(19) United States
(12) Patent Application Publication
(10) Pub. No.: US 2010/0021807 A1
(43) Pub. Date: Jan. 28, 2010

(54) ENERGY STORAGE DEVICE

(76) Inventors: Ha-Young Lee, Anyang-si (KR); Jin-A Kang, Anyang-si (KR); Jong-Suk Park, Anyang-si (KR); Jun-Ho Kim, Anyang-si (KR)

Correspondence Address: STROOCK & STROOCK & LAVAN LLP, 180 MAIDEN LANE, NEW YORK, NY, 10038, US

(21) Appl. No.: 12/507,651

(22) Filed: Jul. 22, 2009

(30) Foreign Application Priority Data
Jul. 24, 2008 (KR) 10-2008-0072357
Aug. 13, 2008 (KR) 10-2008-0079196

(51) Int. Cl. H01M 10/05; H01G 9/058

(52) U.S. Cl. 429/129; 361/502

(57) ABSTRACT

Disclosed is an energy storage device, in which an electrode material including an aqueous solvent, a binder and a transition metal oxide containing lithium is used to form one electrode, and an electrode material including activated carbon is used to form the other electrode. In particular, the energy storage device ensures reliability and maximum capacitance efficiency by optimizing density and thickness values of the electrode materials for the cathode electrode and the anode electrode.

### CROSS-REFERENCE TO RELATED APPLICATIONS

This application claims priority to Korean Patent Application no. 10-2008-0072357, filed on Jul. 24, 2008, and Korean Patent Application no. 10-2008-0079196, filed on Aug. 13, 2008, the entirety of each of which is incorporated herein by reference.

### BACKGROUND OF THE INVENTION

1. Field of the Invention

The present invention relates to an energy storage device, and more particularly, to an energy storage device that ensures high energy density and reliability. In particular, the present invention relates to an energy storage device with maximum capacitance efficiency by optimizing density and thickness values of an electrode material for an electrode.

2. Description of the Related Art

Generally, typical devices for storing an electrical energy include batteries and capacitors.

Ultra capacitors, also known as super capacitors, are energy storage devices that have intermediate characteristics between electrolytic condensers and secondary batteries. Because the ultra capacitors have high efficiency and semi-permanent life characteristics, they are regarded as next generation energy storage devices that can be used with secondary batteries or in place of secondary batteries.

The ultra capacitors may be divided into electric double layer capacitors (EDLCs) and pseudocapacitors according to energy storage mechanism.

The pseudocapacitors use a phenomenon that electric charge is stored on the electrode surface or in an electrode near the electrode surface by an oxidation-reduction reaction, while the EDLCs use a phenomenon that an electric double layer is formed at an interface between an electrode and an electrolyte by electro-static induction of ions, and electric charge is stored in the electric double layer.

The EDLCs use, as an active material of an electrode, a material with a large surface area, for example, activated carbon, and have an electric double layer formed at a contact surface between the electrode material and an electrolyte. That is, electric charge layers with different polarities are generated at an interface between an electrode and a liquid electrolyte by static electricity effect. The generated electric charge distribution is referred to as an electric double layer. Accordingly, the EDLCs have the same capacitance as storage batteries.

However, the EDLCs have different charge/discharge characteristics from the storage batteries. Specifically, the storage batteries show a plateau graph of voltage with time during charge/discharge, while the EDLCs show a linear graph of voltage with time during charge/discharge. Thus, EDLCs allow an easy measure of an amount of charged/discharged energy by measuring a voltage.

Meanwhile, the storage batteries store electric charge using a chemical reaction, while the EDLCs store electric charge using a physical storage, i.e., electric charge is stored in an electric double layer formed at an interface between an electrode and an electrolyte. Accordingly, the EDLCs avoid deterioration caused by their repeated use and provide high reversibility and long cycle life. For this reason, the EDLCs may be substituted for storage batteries in applications requiring fastidious maintenance and long cycle life.

As mentioned above, because the EDLCs store electric charge in an electric double layer formed at an interface between an electrode and an electrolyte using absorption/desorption of ions, they have rapid charge/discharge characteristics, and thus they are suitable for auxiliary power supplies of mobile information and communication equipments, for example mobile phones, notebook computes or PDAs, and besides, main or auxiliary power supplies of electric vehicles, street lamps or uninterrupted power supplies (USPs) that require high capacitance. The EDLCs with various purposes of use should have an electrode with high energy through a wide specific surface area, high output through a low specific resistance and electrochemical stability through suppression of an electrochemical reaction at an interface.

Therefore, activated carbon powder or activated carbon fiber that has a wide specific surface area, is widely used as a main material of an electrode, and for a low specific resistance, it may be mixed with a conductive material or added with metal powder by spray coating. Additionally, more stable electrode materials have been studied to suppress the electrochemical reaction by various methods.

Meanwhile, secondary batteries that can provide high energy density and are widely used in mobile equipments, use metal oxides capable of electrochemical intercalation-deintercalation of lithium as a cathode material and graphite as an anode material. An oxidation and reduction process that lithium ions are intercalated into and deintercalated from a cathode and an anode, is an electrochemically slow reaction and gives a great impact to the structure of active materials included in the cathode and anode, resulting in shortened life. Further, repetition of rapid charge/discharge results in significant reduction in life, which is well known.

U.S. Pat. No. 6,252,762 (hereinafter referred to as Document 1) discloses an energy storage device that uses a transition metal oxide containing lithium as an active material of one electrode and activated carbon as an active material of the other electrode to ensure high energy density, high output and high reliability. However, Document 1 uses an organic solvent such as NMP(1-Methyl-2-Pyrrolidinone) to form a metal oxide electrode. But, the organic solvent generates contaminants, causing an environmental problem.

And, it has been reported that, like Document 1, energy storage devices using a transition metal oxide containing lithium have reduced performance due to moisture which permeates thereinto during formation or assembly of electrodes. That is, an anion, PF₆⁻ derived from an electrolyte salt, LiPF₆ reacts with H₂O to produce HF, as in the below reaction formula 1, which causes deterioration of products.

LiPF₆+H₂O→LiF+POF3+2HF [REACTION FORMULA 1]

### SUMMARY OF THE INVENTION

It is an object of the present invention to solve the problems, and therefore, the present invention provides an energy storage device that uses a transition metal oxide including an aqueous solvent, a binder and lithium as an active material of one electrode and activated carbon as an active material of the other electrode. Generally, an electrode formed using an aqueous solvent has a larger amount of remaining moisture that is absorbed on its surface, than a conventional electrode formed using an organic solvent. To solve the performance reduction problem of a device resulted from the remaining moisture, the present invention suggests density and thickness values of an electrode material.

And, the present invention has another object to provide an energy storage device that ensures high energy density, rapid charge/discharge characteristics and high life reliability.

Further, the present invention has another object to provide an energy storage device that can minimize the occurrence of contaminants during formation of an electrode.

In order to achieve the objects, an energy storage device according to one aspect of the present invention comprises a cathode electrode and an anode electrode, each including a current collector and an electrode material; a cathode lead wire and an anode lead wire; a separator disposed between the cathode electrode and the anode electrode to electrically isolate the cathode electrode and the anode electrode from each other; a housing for receiving the cathode electrode, the anode electrode and the separator; an electrolyte filled in the housing; and a cathode terminal and an anode terminal connected to the cathode lead wire and the anode lead wire, respectively, wherein an electrode material of any one of the cathode electrode and the anode electrode includes an aqueous solvent, a binder for an aqueous solvent and metal oxide, and an electrode material of the other electrode includes activated carbon.

A density correlation between the electrode materials satisfies the following equation,

2≦D₁/D₂≦4 [Equation 1]

where D₁(g/cc) is density of an electrode material including a binder for an aqueous solvent and metal oxide, and D₂(g/cc) is density of an electrode material including activated carbon.

A thickness correlation between the electrodes satisfies the following equation,

1.5≦T₂/T₁≦3 [Equation 2]

where T₁(μm) is thickness of an electrode including a binder for an aqueous solvent and metal oxide, and T₂(μM) is thickness of an electrode including activated carbon.

A density-thickness correlation between the electrode materials satisfies the following equation,

0.857≦{D₁*(T₁−a)}/{D₂*(T₂₂−a)}≦2.571 [Equation 3]

where D₁(g/cc) and T₁(μm) are density of an electrode material including a binder for an aqueous solvent and metal oxide, and thickness of an electrode using the same, respectively, D₂(g/cc) and T₂(μm) are density of an electrode material including activated carbon, and thickness of an electrode using the same, respectively, and ‘a’ (μm) is thickness of a current collector.

The electrolyte contains a fluoroborate ion (BF₄⁻) as an anion, and a lithium ion and an ammonium-based ion as a cation.

The metal oxide is lithium transition metal oxide, and a transition metal of the transition metal oxide is any one selected from the group consisting of nickel(Ni), manganese(Mn), cobalt(Co), iron(Fe), molybdenum(Mo), chrome(Cr), titanium(Ti) and vanadium(V).

The binder for an aqueous solvent is any one selected from the group consisting of carboxymethylcellulose, alginic acid, polyvinylalcohol, polyvinylpyrrolidone, a styrene butadiene rubber dispersion and a fluorocarbon dispersion.

Preferably, an electrode material including the aqueous solvent, the binder for an aqueous solvent and the metal oxide is used to form a cathode electrode, and an electrode material including the activated carbon is used to form an anode electrode.

### BRIEF DESCRIPTION OF THE DRAWINGS

Other objects and aspects of the present invention will become apparent from the following description of embodiments with reference to the accompanying drawings.

FIG. 1 is a front view of an energy storage device according to the present invention.

FIG. 2 is a schematic view of connection of an electrode and a lead wire in the energy storage device according to the present invention.

FIG. 3 is a cross-sectional view of arrangement of an electrode, a lead wire and a separator in the energy storage device according to the present invention.

FIG. 4 is a perspective view of roll-up of a cathode/an anode and a separator in the energy storage device according to the present invention.

### DESCRIPTION OF THE PREFERRED EMBODIMENT

Hereinafter, preferred embodiments of the present invention will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation.

Therefore, the description proposed herein is just a preferable example for the purpose of illustrations only, not intended to limit the scope of the invention, so it should be understood that other equivalents and modifications could be made thereto without departing from the spirit and scope of the invention.

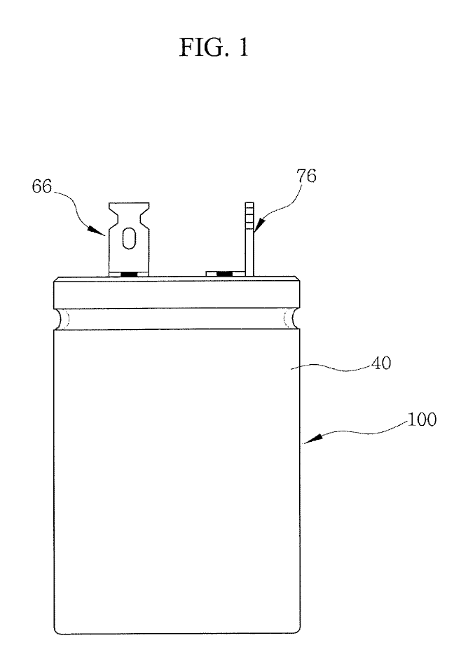

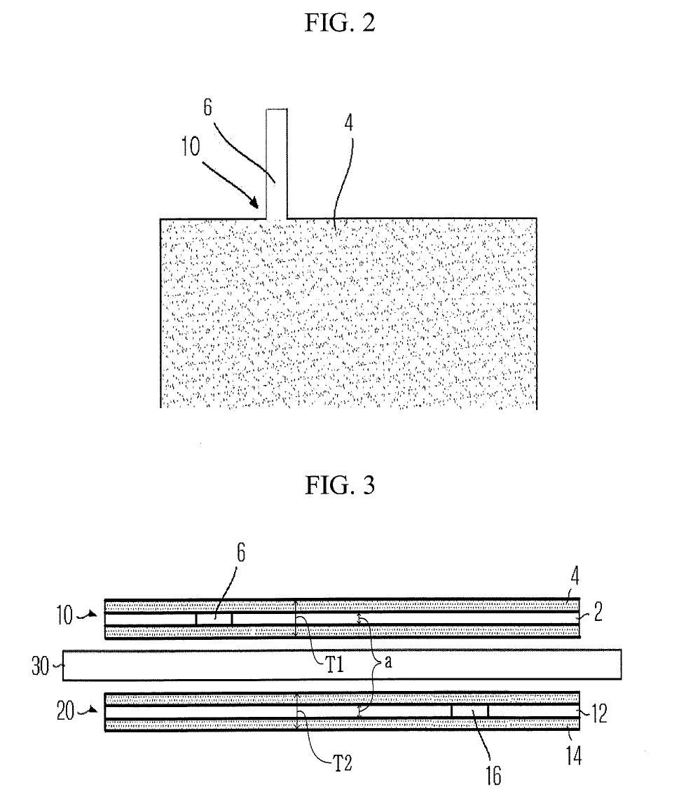

FIG. 1 is a front view of an energy storage device according to the present invention. FIG. 2 is a schematic view of connection of an electrode and a lead wire in the energy storage device according to the present invention.

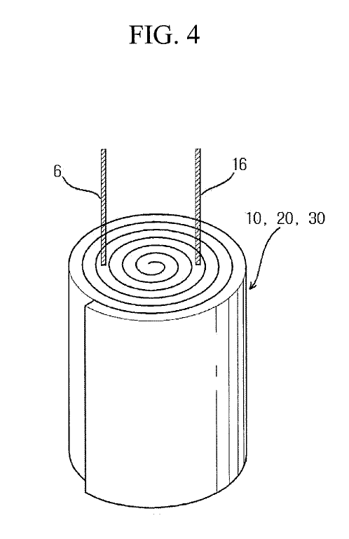

And, FIG. 3 is a cross-sectional view of arrangement of an electrode, a lead wire and a separator in the energy storage device according to the present invention.

Referring to FIGS. 1 to 3, an energy storage device 100 according to the present invention includes a cathode electrode 10 and an anode electrode 20; a cathode lead wire 6 and an anode lead wire 16; a separator 30 disposed between the cathode electrode 10 and the anode electrode 20 to electrically isolate the cathode electrode 10 from the anode electrode 20; a housing 40 for receiving the cathode electrode 10 and the anode electrode 20; an electrolyte filled in the housing 40 and containing a fluoroborate ion (BF₄⁻); and a cathode terminal 66 and an anode terminal 76 connected to the cathode lead wire 6 and the anode lead wire 16, respectively.

The cathode electrode 10 and the anode electrode 20 include current collectors 2 and 12 and electrode materials 4 and 14, respectively. And, the cathode electrode 10 and the anode electrode 20 are connected to the lead wires 6 and 16 at one side thereof, respectively. The electrode material 4 of the cathode electrode 10 is where lithium ions are intercalated/deintercalated by oxidation/reduction reaction, and the electrode material 14 of the anode electrode 20 is where an electric energy is stored through an electric double layer by static electricity effects. The current collectors 2 and 12 serve as flow passages of electric charge.

Generally, the current collectors 2 and 12 are formed in the type of a foil. Any one of the electrode materials 4 and 14 includes a binder for an aqueous solvent and metal oxide, and the other includes activated carbon.

In particular, according to an embodiment of the present invention, preferably the electrode material 4 of the cathode electrode 10 includes a binder, metal oxide and an aqueous solvent, and the electrode material 14 of the anode electrode 20 includes activated carbon.

The aqueous solvent is used to apply/coat the electrode material to/on the opposite surface of the current collector 2. Preferably, the aqueous solvent is water with a specific resistance range of 1 mΩ/cm to 20 mΩ/cm that is free of organic or inorganic substances or microorganisms. The use of pure water as an aqueous solvent can minimize the influence that organic or inorganic substances or microorganisms exert on intercalation/deintercalation of electrolyte ions into/from the electrode material.

And, carboxymethylcellulose, alginic acid, polyvinylalcohol, polyvinylpyrrolidone, a styrene butadiene rubber dispersion or a fluorocarbon dispersion is used as the binder.

And, the metal oxide in the electrode material 4 of the cathode electrode 10 mainly includes lithium transition metal oxide, for example, LiCoO₂, LiMnO₂, LiMn₂O₄ or LiNiO₂. A transition metal of the transition metal oxide may include nickel(Ni), manganese(Mn), cobalt(Co), iron(Fe), molybdenum(Mo), chrome(Cr), titanium(Ti), vanadium(V) and so on.

The electrode material 14 of the anode electrode 20 according to an embodiment of the present invention includes activated carbon, and has a large specific surface area due to micropores of the activated carbon. Accordingly, the electrode material 14 including activated carbon is used as an active material of an anode electrode and its surface is contacted with an electrolyte.

And, a density correlation between the electrode materials 4 and 14 used in the energy storage device 100 according to the present invention satisfies the following equation 1.

2≦D₁/D₂≦4 [EQUATION 1]

where D₁(g/cc) is density of an electrode material including a binder and metal oxide, and D₂(g/cc) is density of an electrode material including activated carbon. At this time, density of an electrode material is defined as its mass per unit volume.

If a value of D₁/D₂ is smaller than 2, capacitance (F) of the energy storage device 100 reduces rapidly. If a value of D₁/D₂ is larger than 4, the electrode material is used with an increased mass per unit volume, so that production costs increase and a resistance value (mΩ) increases, thereby failing to obtain high efficiency.

And, a thickness correlation between the cathode and anode electrodes 10 and 20 in the energy storage device 100 according to the present invention satisfies the following equation 2.

1.5≦T₂/T₁≦3 [EQUATION 2]

where T₁(μm) is thickness of an electrode including a binder for an aqueous solvent and metal oxide, and T₂(μM) is thickness of an electrode including activated carbon.

If a value of T₂/T₁ is smaller than 1.5 or larger than 3, the energy storage device 100 has low efficiency to capacitance (F).

And, a correlation between density of the electrode materials 4 and 14, and thickness of the cathode and anode electrodes 10 and 20 in the energy storage device 100 according to the present invention satisfies the following equation 3.

0.857≦{D₁*(T₁−a)}/{D₂*(T₂−a)}≦2.571 [EQUATION 3]

where D₁(g/cc) and T₁(μm) are density of an electrode material including a binder for an aqueous solvent and metal oxide, and thickness of an electrode using the same, respectively, D₂(g/cc) and T₂(μm) are density of an electrode material including activated carbon, and thickness of an electrode using the same, respectively, and a(μm) is thickness of a current collector.

If a value of {D₁*(T₁−a)}/{D₂*(T₂−a)} is smaller than 0.857, the energy storage device 100 has low efficiency in capacitance (F) and resistance (mΩ). If a value of {D₁*(T₁−a)}/{D₂*(T₂−a)} is larger than 2.571, the energy storage device 100 has satisfactory capacitance (F), but an increase in resistance (mΩ).

The separator 30 is disposed between the cathode electrode 10 and the anode electrode 20 to limit electron conduction therebetween. And, the electrolyte 40 is filled in the housing 40. The electrolyte contains a fluoroborate ion (BF₄⁻) as an anion, and a lithium ion and an ammonium-based ion as a cation. The ammonium-based ion contains an ammonium salt such as tetraethylammonium, tetrafluoroborate or triethymethylammonium, or tetrafluoroborate.

In particular, the present invention uses a fluoroborate ion (BF₄⁻) as an anion to reduce interaction between a lithium ion and water and improve charge/discharge characteristics at low temperature.

Referring to FIG. 4, a stack of the cathode electrode 10, the anode electrode 20 and the separator 30 shown in FIG. 3 are rolled up and then received in the housing 40. The housing 40 is filled with the electrolyte. And, the cathode terminal 66 and the anode terminal 76 connected to the cathode lead wire 6 and the anode lead wire 16, respectively are installed in the housing 40. The cathode terminal 66 and the anode terminal 76 are made from any one selected from the group consisting of aluminium, steel and stainless steel. The cathode terminal 66 and the anode terminal 76 are surface-coated with nickel or tin to ensure bondability by welding or the like.

And, the housing 40 may be made from a metal such as aluminium or an alloy thereof, or a synthetic resin. Preferably, the housing 40 may include an upper housing and a lower housing.

Although FIG. 1 shows the housing 40 of a cylindrical shape, the present invention is not limited in this regard. For example, the housing 40 may have a hexahedral shape.

Preferably, the cathode terminal 66 and the anode terminal 76 face in a perpendicular direction to each other. When the cathode terminal 66 and the anode terminal 76 face in a perpendicular direction to each other, although a bending moment of an external force is applied in any direction, a generally equal support is provided.

The separator 30 according to the present invention may be formed from pulp or polymer-based fibers by a melt-blown process. The pulp is a series of cellulose fibers obtained from wood or plant fiber source by a mechanical and chemical method. The polymer-based synthetic resin may include polyethylene, polypropylene and so on. And, the separator 30 may be formed by making a synthetic resin such as polyethylene or the like in the type of a film and forming micropores into the film.

### EXAMPLE AND COMPARATIVE EXAMPLE

An experiment was made on energy storage devices manufactured according to an example of the present invention and a comparative example.

### Example 1

LiMn₂O₄, a conductive material and a binder were mixed at a weight ratio of about 80:15:5 to prepare a slurry for a cathode electrode. Activated carbon, a conductive material and a binder were mixed at a weight ratio of about 80:15:5 to prepare a slurry for an anode electrode. Each slurry was coated on an aluminium current collector to form a cathode electrode and an anode electrode. At this time, super P was used as the conductive material, and a mixture of PTFE, CMC and SBR was used as the binder. The current collector coated with the slurry was compressed by applying pressure thereto, and dried in a vacuum oven of about 120° C. for about 48 hours.

A capacitor cell was manufactured using a pair of electrodes, a separator and an electrolyte. At this time, the separator is a porous cellulose-based separator, and the capacitor cell has a cylindrical shape. Et4NBF4 and LiBF₄ dissolved in an acetonitrile solvent were used as the electrolyte. The capacitor cell was charged/discharged in an operating voltage range from 2.5V to 1.0V. The capacitance was measured with a current density of 10 mA/cm2, and the resistance was measured in OCV condition at 1 kHz.

### Comparative Example 1

A capacitor cell was manufactured in the same way as example 1, except that PVdF was used as a binder for a cathode electrode and NMP(N-Methyl-2-Pyrrolidinone) was used as an organic solvent.

<Experiment of Capacitance Retention>

A charge/discharge test was performed on capacitor cells of example 1 and comparative example 1 for 10,000 cycles according to IEC 62391-1 standard, and capacitance retention was measured. The measurement results are shown in Table 1.

An initial capacitance (Ci) was measured at normal temperature, and after charge/discharge with currents of 8 A for 10,000 cycles, a cyclic capacitance (Ct) was measured for each capacitor cell of example 1 and comparative example 1.

A capacitance retention was calculated using the measured capacitance values. Capacitance retention(%)=[(Ci−Ct)/Ci]×100

TABLE 1

| Classification | Example 1 | Comparative example 1 |
|---|---|---|
| Capacitance(F) | 204 | 208 |
| Resistance(mΩ) | 9.25 | 11 |
| Capacitance | 90 | 87 |
| retention(%) | | |

As seen from Table 1, the capacitor cells of example 1 and comparative example 1 have 90% and 87% of capacitance retention after 10,000-cycle charge/discharge, respectively. It is found that the use of an aqueous solvent to a cathode electrode does not affect a cyclic capacitance, nor generate contaminants, and provides sufficient durability.

### Example 2

LiMn₂O₄, a conductive material and a binder were mixed at a weight ratio of about 80:15:5 to prepare a slurry for a cathode electrode. Activated carbon, a conductive material and a binder were mixed at a weight ratio of about 80:15:5 to prepare a slurry for an anode electrode. Each slurry was coated on an aluminium current collector to form a cathode electrode and an anode electrode. At this time, super P was used as the conductive material, and a mixture of PTFE, CMC and SBR was used as the binder. The current collector coated with the slurry was compressed by applying pressure thereto, and dried in a vacuum oven of about 120° C. for about 48 hours.

A capacitor cell was manufactured using a pair of electrodes, a separator and an electrolyte. At this time, the separator is a porous cellulose-based separator, and the capacitor cell has a cylindrical shape. LiBF₄ dissolved in an acetonitrile solvent was used as the electrolyte. The capacitor cell was charged/discharged in an operating voltage range from 2.5V to 1.0V. The capacitance was measured with a current density of 10 mA/cm2, and the resistance was measured in OCV condition at 1 kHz.

### Comparative Example 2

A capacitor cell was manufactured in the same way as example 2, except that LiPF₆ was used as an electrolyte salt of an electrolyte.

<Experiment of Capacitance Retention at High Temperature>

After the capacitor cells of example 2 and comparative example 2 were stored at high temperature for 500 hours according to IEC 62391-1 standard, their capacitance retention at high temperature was measured. The measurement results are shown in Table 2.

Specifically, an initial capacitance (Ci) was measured at normal temperature. After the capacitor cells of example 2 and comparative example 2 were applied with a voltage of 2.5V at 60° C. for 500 hours and put aside at normal temperature for 12 hours, a cyclic capacitance (Ct) was measured.

Capacitance retention at high temperature was calculated using the measured capacitance values. Capacitance retention at high temperature (%)=[(Ci−Ct)/Ci]×100

<Experiment of Capacitance Retention at Low Temperature>

The capacitance retention at low temperature for the capacitor cells of example 2 and comparative example 2 was measured according to IEC 62391-1 standard. The measurement results are shown in Table 2.

Specifically, an initial capacitance (Ci) was measured at normal temperature. After the capacitor cells of example 2 and comparative example 2 were put aside at −25° C. for 3 hours, a cyclic capacitance (Ct) was measured.

Capacitance retention at low temperature was calculated using the measured capacitance values. Capacitance retention at low temperature(%)=[(Ci−Ct)/Ci]×100

<Experiment of Reactivity with Water>

The capacitor cells of example 2 and comparative example 2 have the same number of mols of an electrolyte and the same ppm of water. The leak current of the capacitor cells was measured.

TABLE 2

| Classification | Example 2 | Comparative example 2 |
|---|---|---|
| Capacitance retention | 81 | 76 |
| at high temperature(%) | | |
| Capacitance retention | 85 | 10 |
| at low temperature(%) | | |
| Leak current(mA) | 0.123 | 0.293 |

As seen from Table 2, the capacitor cells of example 2 and comparative example 2 have 81% and 76% of capacitance retention at high temperature, and 85% and 10% of capacitance retention at low temperature, respectively. That is, the capacitor cell of example 2 using LiBF₄ as an electrolyte salt has better capacitance retention at high temperature and capacitance retention at low temperature than the capacitor cell of comparative example 2 using LiPF₆ as an electrolyte salt.

And, it is found through the experiment of reactivity with water that a leak current of comparative example 2 is relatively greater than that of example 2. That is, LiBF₄ has less reactivity with water than LiPF₆.

### Example 3

1M LiBF₄ and 1M TEATFB (tetraethylammonium tetrafluoroborate) were dissolved, as an electrolyte salt, in a mixed solvent of propylene carbonate (PC) and ethylene carbonate (EC) to prepare an electrolyte. Conductivity of the electrolyte was measured by Orion Conductivity Meter.

### Example 3-1

An electrolyte was prepared in the same way as example 3, except that acetonitrile was used as a solvent of the electrolyte. Conductivity of the electrolyte was measured by Orion Conductivity Meter.

### Comparative Example 3

An electrolyte was prepared in the same way as example 3, except that 1M LiPF₆ was used as an electrolyte salt. Conductivity of the electrolyte was measured by Orion Conductivity Meter.

### Comparative Example 3-1

An electrolyte was prepared in the same way as example 3, except that 1M LiBF₄ was used as an electrolyte salt. Conductivity of the electrolyte was measured by Orion Conductivity Meter.

### Comparative Example 3-2

An electrolyte was prepared in the same way as example 3-1, except that 1M LiBF₄ was used as an electrolyte salt. Conductivity of the electrolyte was measured by Orion Conductivity Meter.

<Experiment of Electrical Conductivity>

The electrical conductivity was measured at normal temperature for each capacitor cell manufactured using the electrolytes according to examples 3 and 3-1 and comparative examples 3, 3-1 and 3-2. The measurement results are shown in Table 3.

TABLE 3

| | Example | Example | Comparative | Comparative | Comparative |
|---|---|---|---|---|---|
| | 3 | 3-1 | example 3 | example 3-1 | example 3-2 |
| Electrical | 7.05 | 40.7 | 6.56 | 4.25 | 19.15 |
| conductivity | | | | | |
| (ms/cm) | | | | | |

As seen from Table 3, example 3 using a mixed solvent of EC and PC has higher electrical conductivity than comparative examples 3 and 3-1 using the same solvent as example 3. And, example 3-1 using acetonitrile as a solvent of an electrolyte has higher electrical conductivity than comparative example 3-2 using the same solvent as example 3-1.

Accordingly, it is found that an electrolyte including 1M LiBF₄ and 1M TEATFB as a supporting electrolyte has a remarkable improvement in electrical conductivity.

### Example 4

A capacitor cell was manufactured in the same way as example 1, except that density (D₁,D₂) of electrode materials and thickness (T₁,T₂) of cathode and anode electrodes follow Table 4-1.

### Examples 4-1 to 4-4

A capacitor cell was manufactured in the same way as example 4, except that density (D₁,D₂) of electrode materials and thickness (T₁,T₂) of cathode and anode electrodes follow Table 4-1.

### Comparative Examples 4 and 4-1

A capacitor cell was manufactured in the same way as example 4, except that density (D₁,D₂) of electrode materials, thickness (T₁,T₂) of cathode and anode electrodes follow Table 4-1.

TABLE 4-1

| | Example | Example | Example | Example | Example | Comparative | Comparative |
|---|---|---|---|---|---|---|---|
| | 4 | 4-1 | 4-2 | 4-3 | 4-4 | example 4 | example 4-1 |
| D₁ (g/cc) | 1.2 | 1.8 | 2.4 | 2.4 | 2.4 | 0.6 | 2.6 |
| D₂ (g/cc) | 0.6 | 0.6 | 0.6 | 0.6 | 0.6 | 0.6 | 0.6 |
| D₁/D₂ | 2.0 | 3.0 | 4.0 | 4.0 | 4.0 | 1.0 | 4.3 |
| T₁ (μm) | 80 | 80 | 80 | 90 | 110 | 80 | 120 |
| T₂ (μm) | 160 | 160 | 160 | 160 | 160 | 160 | 160 |
| T₂/T₁ | 2.0 | 2.0 | 2.0 | 1.8 | 1.5 | 2.0 | 1.3 |
| a (μm) | 20 | 20 | 20 | 20 | 20 | 20 | 20 |
| {D₁*(T₁ − a)}/ | 0.857 | 1.286 | 1.714 | 2.000 | 2.571 | 0.429 | 3.095 |
| {D₂*(T₂ − a)} | | | | | | | |

Here, D₁(g/cc) and T₁(μm) are density of an electrode material including a binder and metal oxide, and thickness of an electrode using the same, respectively, D₂(g/cc) and T₂(μm) are density of an electrode material including activated carbon, and thickness of an electrode using the same, respectively, and ‘a’ (μm) is thickness of a current collector.

The capacitance (F) and resistance (mΩ) were measured for each capacitor cell of examples 4 to 4-4 and comparative 4 and 4-1. The measurement results are shown in Table 4-2.

TABLE 4-2

| | Example | Example | Example | Example | Example | Comparative | Comparative |
|---|---|---|---|---|---|---|---|
| | 4 | 4-1 | 4-2 | 4-3 | 4-4 | example 4 | example 4-1 |
| Resistance (mΩ) | 7 | 7.2 | 7.1 | 7.3 | 7.2 | 7.9 | 8 |
| Capacitance (F) | 136 | 142 | 149 | 150 | 149 | 77 | 145 |

As seen from Table 4-2, the capacitor cells of example 4 to 4-4 have a stable capacitance range from 136 F to 150 F and a stable resistance range from 7 mΩ to 7.3 mΩ. However, the capacitor cells of comparative examples 4 and 4-1 have rapid reduction in capacitance or rapid increase in resistance.

Accordingly, for efficient and stable operation of an energy storage device, a value of D₁/D₂ is preferably 2 to 4.

### Example 5

A capacitor cell was manufactured in the same way as example 1, except that density (D₁, D₂) of electrode materials and thickness (T₁,T₂) of cathode and anode electrodes follow Table 5-1.

### Examples 5-1 and 5-2

A capacitor cell was manufactured in the same way as example 5, except that density (D₁, D₂) of electrode materials and thickness (T₁,T₂) of cathode and anode electrodes follow Table 5-1.

### Comparative Examples 5 and 5-1

A capacitor cell was manufactured in the same way as example 5, except that density (D₁,D₂) of electrode materials and thickness (T₁,T₂) of cathode and anode electrodes follow Table 5-1.

TABLE 5-1

| | Example | Example | Example | Comparative | Comparative |
|---|---|---|---|---|---|
| | 5 | 5-1 | 5-2 | example 5 | example 5-1 |
| D₁ (g/cc) | 1.8 | 1.8 | 1.8 | 1.8 | 1.8 |
| D₂ (g/cc) | 0.6 | 0.6 | 0.6 | 0.6 | 0.6 |
| D₁/D₂ | 3.0 | 3.0 | 3.0 | 3.0 | 3.0 |
| T₁ (μm) | 76 | 103 | 123 | 58 | 164 |
| T₂ (μm) | 190 | 190 | 190 | 190 | 190 |
| T₂/T₁ | 2.5 | 1.8 | 1.5 | 3.3 | 1.2 |
| a (μm) | 20 | 20 | 20 | 20 | 20 |
| {D₁*(T₁ − a)}/ | 0.988 | 1.465 | 1.818 | 0.671 | 2.541 |
| {D₂*(T₂ − a)} | | | | | |

Here, D₁(g/cc) and T₁(μm) are density of an electrode material including a binder and metal oxide, and thickness of an electrode using the same, respectively, D₂(g/cc) and T₂(μm) are density of an electrode material including activated carbon, and thickness of an electrode using the same, respectively, and ‘a’ (μm) is thickness of a current collector.

The capacitance (F) was measured for each capacitor cell of examples 5 to 5-2 and comparative 5 and 5-1. The measurement results are shown in Table 5-2.

TABLE 5-2

| | Example | Example | Example | Comparative | Comparative |
|---|---|---|---|---|---|
| | 5 | 5-1 | 5-2 | example 5 | example 5-1 |
| Capacitance (F) | 145.72 | 138.05 | 130.25 | 121.62 | 111.51 |

As seen from Table 5-2, the capacitor cells of example 5 to 5-2 have a stable capacitance range from about 130° F. to about 145° F. However, the capacitor cells of comparative examples 5 and 5-1 have a reduction in capacitance. Accordingly, for efficient and stable operation of an energy storage device, a value of T₂/T₁ is preferably 1.5 to 3.

Therefore, it is found through examples 4 and 5 that an optimum correlation between density (D₁,D₂) of electrode materials and thickness (T₁,T₂) of cathode and anode electrodes satisfies 0.857≦{D₁*(T₁−a)}/{D₂*(T₂−a)}≦2.571.

### APPLICABILITY TO THE INDUSTRY

Accordingly, the present invention provides an energy storage device that ensures maximum capacitance efficiency, high energy density, rapid charge/discharge characteristics and high life reliability.

And, the present invention can minimize contaminants that may occur during formation of an electrode.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An energy storage device, comprising:
a cathode electrode and an anode electrode, each including a current collector and an electrode material;
a cathode lead wire and an anode lead wire;
a separator disposed between the cathode electrode and the anode electrode to electrically isolate the cathode electrode and the anode electrode from each other;
a housing for receiving the cathode electrode, the anode electrode and the separator;
an electrolyte filled in the housing; and
a cathode terminal and an anode terminal connected to the cathode lead wire and the anode lead wire, respectively,
wherein the electrode material of any one of the cathode electrode and the anode electrode includes an aqueous solvent, a binder for an aqueous solvent and metal oxide, and the electrode material of the other electrode includes activated carbon.

2. The energy storage device according to claim 1,
wherein a density correlation between the electrode materials satisfies the following equation,
2≦D₁/D₂≦4
where D₁ is the density of the electrode material including a binder for an aqueous solvent and metal oxide, and D₂ is the density of the electrode material including activated carbon.

3. The energy storage device according to claim 2,
wherein a thickness correlation between the electrodes satisfies the following equation,
1.5≦T₂/T₁≦3
where T₁ is the thickness of the electrode including a binder for an aqueous solvent and metal oxide, and T₂ is the thickness of the electrode including activated carbon.

4. The energy storage device according to claim 3,
wherein a density-thickness correlation between the electrode materials satisfies the following equation,
0.857≦{D₁*(T₁−a)}/{D₂*(T₂−a)}≦2.571
where D₁ and T₁ are the density of the electrode material including a binder for an aqueous solvent and metal oxide, and the thickness of the electrode using the same, respectively, D₂ and T₂ are the density of the electrode material including activated carbon, and the thickness of the electrode using the same, respectively, and ‘a’ is the thickness of the current collector.

5. The energy storage device according to claim 1,
wherein the electrolyte contains BF₄⁻.

6. The energy storage device according to claim 5,
wherein the metal oxide is lithium transition metal oxide.

7. The energy storage device according to claim 6,
wherein the electrolyte contains a lithium ion and an ammonium-based ion as a cation.

8. The energy storage device according to claim 7,
wherein a density correlation between the electrode materials satisfies the following equation,
2≦D₁/D₂≦4
where D₁ is the density of the electrode material including a binder for an aqueous solvent and metal oxide, and D₂(g/cc) is the density of the electrode material including activated carbon.

9. The energy storage device according to claim 8,
wherein a thickness correlation between the electrodes satisfies the following equation,
1.5≦T₂/T₁≦3
where T₁ is the thickness of the electrode including a binder for an aqueous solvent and metal oxide, and T₂ is the thickness of the electrode including activated carbon.

10. The energy storage device according to claim 9,
wherein a density-thickness correlation between the electrode materials satisfies the following equation,
0.857≦{D₁*(T₁−a)}/{D₂*(T₂−a)}≦2.571
where D₁ and T₁ are the density of the electrode material including a binder for an aqueous solvent and metal oxide, and the thickness of the electrode using the same, respectively, D₂ and T₂ are the density of the electrode material including activated carbon, and the thickness of the electrode using the same, respectively, and ‘a’ is the thickness of the current collector.

11. The energy storage device according to claim 10,
wherein a transition metal of the transition metal oxide is any one selected from the group consisting of Ni, Mn, Co, Fe, Mo, Cr, Ti, and V.

12. The energy storage device according to claim 11,
wherein the binder for an aqueous solvent is any one selected from the group consisting of carboxymethylcellulose, alginic acid, polyvinylalcohol, polyvinylpyrrolidone, a styrene butadiene rubber dispersion and a fluorocarbon dispersion.

13. The energy storage device according to claim 1,
wherein the electrode material including the aqueous solvent, the binder for an aqueous solvent and the metal oxide is used to form the cathode electrode, and the electrode material including the activated carbon is used to form the anode electrode.
